(19) United States
(12) Patent Application Publication
(10) Pub. No.: US 2008/0155777 A1
(43) Pub. Date: Jul. 3, 2008

(54) Windshield wiper with adjustable bearing force

(75) Inventor: Brock Stull, Raymond, OH (US)

Correspondence Address: BROUSE MCDOWELL LPA, 388 SOUTH MAIN STREET, SUITE 500, AKRON, OH, 44311, US

(73) Assignee: Honda R&D Americas, Inc.

(21) Appl. No.: 11/649,037

(22) Filed: Dec. 31, 2006

(51) Int. Cl. B60S 1/40

(52) U.S. Cl. 15/250.202; 15/250.351; 15/250.352

(57) ABSTRACT

A windshield wiper for clearing environmental debris from a windscreen provided to a motor vehicle. The windshield wiper comprises an arm support to be coupled to a rotatable pivot head provided to the motor vehicle for oscillating the windshield wiper during operation thereof, and a wiper arm coupled to the arm support and supporting a wiper blade that contacts the windscreen with a desired bearing force. A first spring fastener is provided to the arm support and a second spring fastener is provided to the wiper arm and separated from the first spring fastener by a first distance when the windshield wiper is assembled. At least one additional spring fastener is provided to the wiper arm, the arm support, or both the wiper arm and the arm support. A spring is coupled at a first end to one of the first spring fastener or the second spring fastener and a second end that is coupled to another of the first spring fastener, the second spring fastener or an additional spring fastener to establish the desired bearing force with which the wiper blade contacts the windscreen.

### BACKGROUND OF THE INVENTION

1. Field of the Invention

The present invention is directed generally to a windshield wiper for a motor vehicle, and more specifically, to a windshield wiper having an adjustable spring for varying a bearing force imparted by the wiper on a window of the motor vehicle.

2. Description of Related Art

Traditionally, windshield wipers for motor vehicles have included a wiper arm that is pivotally coupled with a hinge pin to an arm support and supports a wiper blade. The arm support is secured to a pivot head that is driven by an electric motor to oscillate the wiper arm, and accordingly, the wiper blade back and forth over the windshield of the motor vehicle to remove moisture and debris there from.

Conventional windshield wipers have also employed a biasing device that urges the wiper arm toward the windshield to establish a predetermined bearing force applied by the wiper blade on the windshield. One such biasing device is a spring that is extended between the arm support and the wiper arm. The spring is extended beyond its unbiased length to create a tensile force between the arm support and the wiper arm, thereby urging the wiper arm to rotate about the hinge pin in a direction toward the windshield. The resulting bearing force imparted by the wiper blade onto the windshield serves to minimize the amount of moisture and debris that can pass between the wiper blade and windshield during operation of the windshield wiper.

Depending on the environments in which the motor vehicle with the windshield wiper is to be used, the desired bearing force imparted by the wiper blade on the windshield will vary. Geographic regions that experience harsh winter environments that will deposit ice, sleet and other forms of precipitation that are difficult to remove onto the motor vehicle's windshield will require a greater bearing force from the wiper blade than geographic regions with a mild climate. However, imparting the large bearing force required for harsh winter climates on the windshield with the wiper blade in a tropical climate can lead to premature wearing of the wiper blade and streaking of the windshield. Thus, installing a common spring on all motor vehicles that will cause the wiper blade to impart the greatest bearing force on the windshield required by any environment is undesirable.

Attempts have been made to provide a windshield wiper with a wiper blade that can impart an adjustable bearing force on the windshield of a motor vehicle for given environments. For example, one such windshield wiper included an electrical solenoid that was operatively coupled between the wiper arm and the arm support to urge rotation of the wiper arm about the hinge pin and toward the windshield of the motor vehicle. Such an arrangement necessarily requires an electrical solenoid, complex electrical control circuitry for controlling operation of the solenoid, and other components in addition to the spring included to establish the base bearing force imparted by the wiper blade on the windshield. But when the motor vehicle is exposed to sub-freezing temperatures, snow, sleet, freezing rain and other winter weather conditions, these electrical features are exposed to the elements, making the system prone to malfunctions. Further, such a windshield wiper requires many features in addition to a spring between the wiper arm and the arm support to establish the base bearing force under less sever weather conditions. This adds to the complexity, and accordingly, the cost to assemble a motor vehicle including this windshield wiper.

Another attempt at providing a windshield wiper with an adjustable bearing force on the windshield of a motor vehicle included an adjustable threaded nut through which a threaded shaft extended. A spring was extended between the arm support of the windshield wiper and a terminal end of the threaded shaft. When adjustment of the tensile force applied by the spring was desired, the threaded nut could be rotated to cause the cooperation of the threads provided to the nut and the shaft to translate the shaft in either toward or away from the arm support. Although such an arrangement allowed for adjustment of the bearing force imparted by the wiper blade on the windshield, even small adjustments were time consuming, requiring many rotations of the threaded nut. The threading of the shaft, the nut, or both the shaft and the nut is also prone to becoming fouled or otherwise obstructed by ice or other environmental debris to which the motor vehicle is exposed. Further, installation of the combination of the threaded nut, threaded shaft and spring during assembly of the motor vehicle is time consuming, delaying production of said motor vehicle.

Accordingly, there is a need in the art for a windshield wiper with an adjustable bearing force for removing environmental elements from a window of a motor vehicle. Such a windshield wiper is readily installed on the motor vehicle, and allows for simple adjustment of the bearing force among a plurality of distinct and predetermined settings without requiring electric control circuitry.

### BRIEF SUMMARY OF THE INVENTION

According to one aspect, the present invention provides a windshield wiper for clearing environmental debris from a windscreen provided to a motor vehicle. The windshield wiper comprises an arm support to be coupled to a rotatable pivot head provided to the motor vehicle for oscillating the windshield wiper during operation thereof, and a wiper arm coupled to the arm support and supporting a wiper blade that contacts the windscreen with a desired bearing force. A first spring fastener is provided to the arm support and a second spring fastener is provided to the wiper arm and separated from the first spring fastener by a first distance. At least one additional spring fastener is provided to the wiper arm and separated a second distance from the first spring fastener, wherein the first and second distances are different. A spring having a first end coupled to the first spring fastener and a second end that is coupled to one of the second spring fastener and the additional spring fastener to establish the desired bearing force with which the wiper blade contacts the windscreen.

According to another aspect, the present invention provides a windshield wiper for clearing environmental debris from a windscreen provided to a motor vehicle. The windshield wiper comprises an arm support to be coupled to a rotatable pivot head provided to the motor vehicle for oscillating the windshield wiper during operation thereof, and a wiper arm coupled to the arm support and supporting a wiper blade that contacts the windscreen with a desired bearing force. A first spring fastener is provided to the arm support, and a second spring fastener provided to the wiper arm and separated from the first spring fastener by a first distance. At least one additional spring fastener is provided to the arm support and separated a second distance from the second spring fastener, wherein the first and second distances are different. A spring having a second end coupled to the second spring fastener and a first end that is coupled to one of the first spring fastener and the additional spring fastener to establish the desired bearing force with which the wiper blade contacts the windscreen.

### BRIEF DESCRIPTION OF THE DRAWINGS

The invention may take physical form in certain parts and arrangement of parts, embodiments of which will be described in detail in this specification and illustrated in the accompanying drawings which form a part hereof, and wherein:

FIG. 1 is a perspective view of a windscreen provided to a motor vehicle that can have environmental debris cleared by a windshield wiper in accordance with an embodiment of the present invention;

FIG. 2a is a side view of a windshield wiper in contact with a windscreen in accordance with an embodiment of the present invention;

FIG. 2b is a side view of portion of a windshield wiper with hidden features shown by broken lines in accordance with an embodiment of the present invention;

FIG. 3 is a partial cutaway view of a portion windshield wiper in accordance with an embodiment of the present invention;

FIG. 4 is a bottom view looking into an interior cavity formed in a wiper arm in which a portion, or all of a spring can be disposed;

FIG. 5 is a side view of portion of a windshield wiper with hidden features shown by broken lines in accordance with an embodiment of the present invention; and

FIG. 6 is a side view of portion of a windshield wiper with hidden features shown by broken lines in accordance with an embodiment of the present invention.

### DETAILED DESCRIPTION OF ILLUSTRATIVE EMBODIMENTS

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

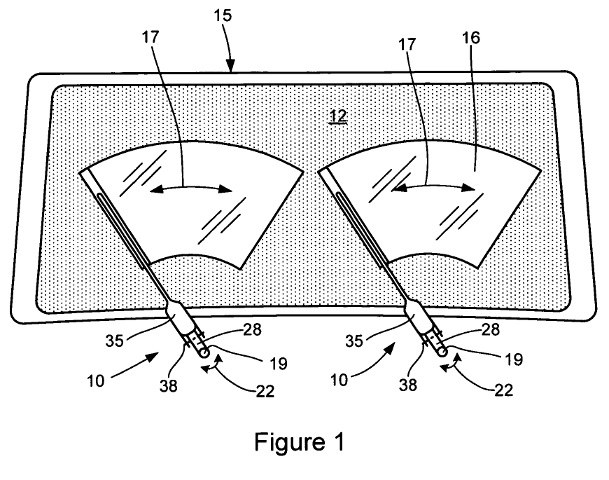

FIG. 1 shows an illustrative embodiment of a windshield wiper 10 for clearing environmental debris from a windscreen 12 provided to a motor vehicle 15. Windshield wipers 10, such as that of the present invention are commonly found on conventional motor vehicles 15 such as cars, trucks, buses and the like. During operation of the motor vehicle 15 in inclement weather conditions environmental debris such as snow, sleet, rain, dust, dirt, and other such debris can be deposited on a surface of the windscreen 12 through which an operator of the motor vehicle 15 must have a clear line of sight to safely navigate the motor vehicle 15. Clearing such environmental debris from the windscreen 12 does not necessarily require the complete removal of the environmental debris. Instead, clearing the environmental debris as described herein merely requires the windshield wiper 10 to relocate said environmental debris from at least a portion 16 of the windscreen 12 to provide the operator with a reasonably unobstructed line of sight for driving the motor vehicle 15.

The windscreen 12 referred to throughout the description of the present invention is also interchangeably referring to and shown in the figures as a front windshield 12 of the motor vehicle 15, positioned in front of the operator while the motor vehicle 15 is operated in a forward direction. However, it is to be understood that the present invention is not limited for use in clearing environmental debris from the front windshield of a motor vehicle 15. The windscreen 12 referred to herein includes any substantially-transparent pane of material from which environmental debris is to be cleared to minimize the obstruction of light passing there through. An example of another substantially-transparent pane of material is a rear window provided to a sport utility vehicle or hatchback automobile. Accordingly, the windshield wiper 10 can be positioned adjacent to any such windscreen 12.

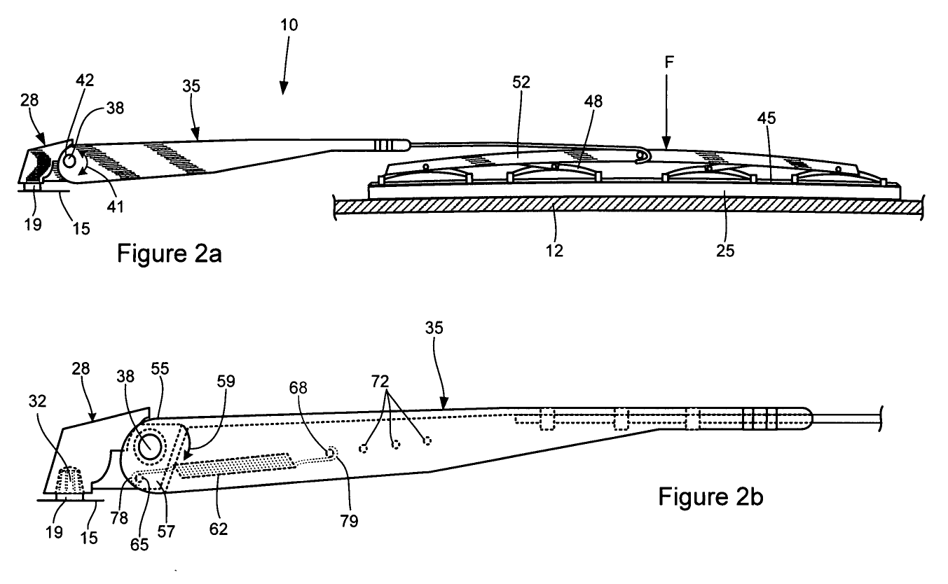

During operation, the windshield wiper 10, and more specifically, a wiper blade 25 (FIG. 2a) is oscillated transversely across the windscreen 12 as indicated by arrow 17. The motivational force necessary for oscillating the windshield wiper 10 is transmitted to the windshield wiper 10 by a rotatable pivot head 19 provided to the motor vehicle 15. The pivot head 19 is operatively secured to an electric motor (not shown) concealed by body paneling of the motor vehicle 15. The electric motor causes alternating oscillation of the pivot head 19, and accordingly the windshield wiper 10, in both the clockwise and counter-clockwise directions indicated by arrow 22 shown in FIG. 1.

FIG. 2a is a side view illustrating cooperation of the wiper blade 25 provided to the windshield wiper 10 with the windscreen 12 of the motor vehicle 15. An arm support 28 is coupled to the rotatable pivot head 19. According to the embodiments shown in the figures, the pivot head 19 is a male protrusion extending outwardly generally away from an exterior surface of the body panel provided to the motor vehicle 15. The arm support 28 includes a female recess 32 (FIG. 2b) formed therein for receiving the pivot head 19 to cause alternating rotation of the arm support 28 along with the pivot head 19. An external surface of the pivot head 19 and the internal periphery of the recess 32 formed in the arm support 28 can optionally be provided with compatible and interlocking teeth to minimize slippage of the arm support 28 about the pivot head 19 during operation of the windshield wiper 10. However, it is to be noted that the present invention is not limited to a female recess 32 for receiving a pivot head 19 in the form of a male extension. The windshield wiper 10 can include any compatible coupling features provided to facilitate an operable connection between the arm support 28 and a wiper arm 35.

The wiper arm 35 is coupled to the arm support 28 for supporting the wiper blade 25 that contacts the windscreen 12 with a desired bearing force in the direction of arrow F. The connection between the arm support 28 and the wiper arm 35 can optionally be a pivotal coupling allowing the wiper arm 35 to pivot in directions indicated by arrow 41 about a hinge pin 38 extending through at least one aperture 42 formed in both the arm support 28 and the wiper arm 35. However, in the event the connection between the arm support 28 and the wiper arm 35 does not include the hinge pin 38, a material that is at least partially elastically deformable extends between the arm support 28 and the wiper arm 35 to permit at least minor pivoting of the wiper arm 35 both toward and away from the windscreen 12. Both the arm support 28 and the wiper arm 35 are fabricated from a suitably durable weather resistant material such as a metal, metal alloy, plastic or plastic compound, for example, to minimize the effect of the environmental debris on the windshield wiper 10.

The wiper blade 25 includes a metallic spline 45 that runs along an external edge of the wiper blade 25 opposite an edge of the wiper blade 25 that contacts the windscreen 12. A plurality of blade supports 48 are periodically secured to the metallic spline 45 for coupling the wiper blade 25 to a rigid blade frame 52. The blade supports 48 allow for minor deformation of the wiper blade 25 as the windshield wiper 10 is oscillated across the windscreen 12 to minimize damage to both the windscreen 12 and the windshield wiper 10 while providing the windshield wiper 10 with the maximum environmental debris clearing abilities. Embodiments of the windshield wiper 10 include a blade frame 52 that can be removed from the wiper arm 35 and replaced when the wiper blade 25 has become worn and needs to be replaced.

As shown in FIG. 2b, a spring 62 or other suitable biasing member for urging rotation of the wiper arm 35 about hinge pin 38 generally toward the windscreen 12 is extended between the arm support 28 and the wiper arm 35. The rotational force imparted by the spring 62 urging this rotation of the wiper arm 35 generally toward the windscreen 12 establishes the desired bearing force F with which the wiper blade 25 contacts the windscreen 12. The bearing force F is approximately normal to the surface of the windscreen 12 in contact with the wiper blade 25 to maximize the windshield clearing abilities of the wiper blade 25 approximately uniformly along the length of the wiper blade 25. Again, the approximate direction of the bearing force F imparted by the wiper blade 25 on the windscreen 12 is illustrated by the arrow F in FIG. 2a.

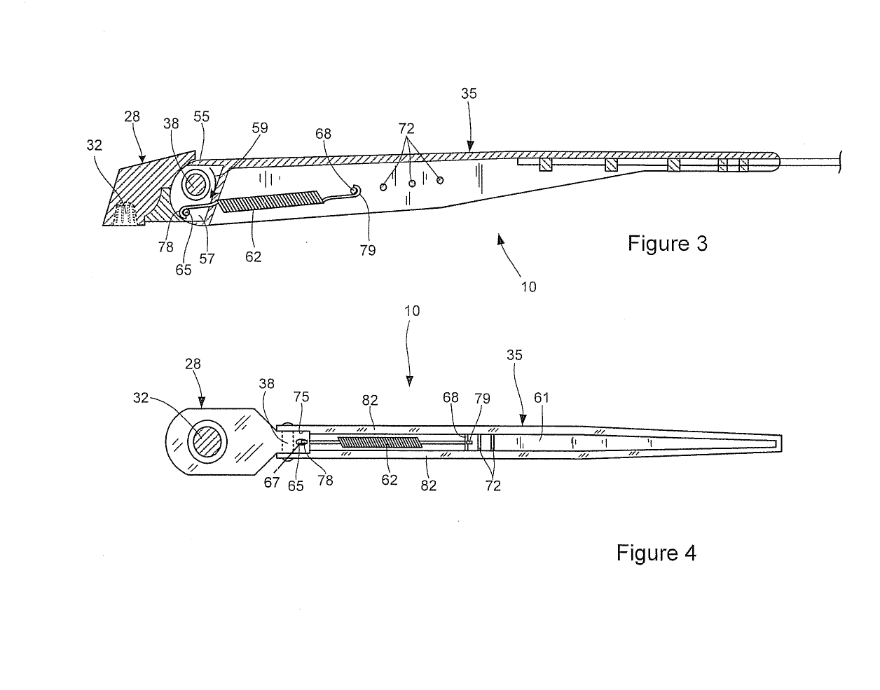

FIG. 2b shows a portion of the wiper arm 35 adjacent to the coupling between the wiper arm 35 and the arm support 28, with hidden features shown as broken lines. FIG. 3 illustrates a similar view of the portion of the wiper arm 35 shown in FIG. 2b, but with a lateral sidewall 82 of the wiper arm 35 and a lateral sidewall 75 of the arm support 28 cutaway. Similar to FIG. 2a, FIGS. 2b and 3 illustrate an embodiment including a pivotal coupling between the wiper arm 35 and the arm support 28. The hinge pin 38 extends through both a proximate end 55 of the wiper arm 35 and a distal end 57 of the arm support 28. This pivotal connection allows for rotation of the wiper arm 35 about the hinge pin 38 generally toward the windscreen 12 in the direction of arrow 59 when subjected to the biasing force imparted on the wiper arm 35 by a spring 62.

The wiper arm can have a cross sectional shape similar to an upside down “U” thereby defining an internal cavity 61, shown in FIG. 4, within the wiper arm 35 having an opening facing downward, generally toward the motor vehicle when the windshield wiper 10 is installed on the motor vehicle. The spring 62 can optionally be at least partially disposed within that interior cavity 61 defined by the wiper arm 35. Other embodiments fully dispose the spring 62 within the interior cavity 61 of the wiper arm 35.

As shown in FIGS. 3 and 4, the spring 62 extends between a first spring fastener 65 provided to the arm support 28 and a second spring fastener 68 provided to the wiper arm 35. The second spring fastener 68 is separated from the first spring fastener 65 by a fixed, predetermined distance which creates a given tension on the spring 62 when stretched to be secured between the first and second spring fasteners 65, 68. The bearing force F imparted by the wiper blade 25 onto the windscreen 12 as a result of the tension of the spring 62 extended between the first and second spring fasteners 65, 68 is minimal due to the extent to which the spring 62 is stretched beyond its natural, un-stretched state to span the distance between the first and second spring fasteners 65, 68.

The bearing force F with which the wiper blade 25 contacts the windscreen 12 can be increased from the bearing force generated with the spring 62 extending between the first and second spring fasteners 65, 68 by coupling the spring 62 between the first spring fastener 65 and an additional spring fastener 72 also provided to the wiper arm 35. The additional spring fastener 72 is also separated from the first spring fastener 65 by a fixed, predetermined distance, but the distance between the first spring fastener 65 and each additional spring fastener 72 is greater than the distance separating the second spring fastener 68 and the first spring fastener 65. To span this greater distance between the first spring fastener 65 and the one or more additional spring fasteners 72, the spring 62 must be stretched further from its un-stretched or unbiased state. Likewise, a plurality of additional spring fasteners 72 can be provided substantially in series at ever-increasing linear distances from the first spring fastener 65 provided to the arm support 28. The greater the spring 62 must be stretched from its unbiased state to span the distance between the first spring fastener 65 and the second spring fastener 68 or one of the additional spring fasteners 72, the greater the resulting bearing force F that is imparted on the windscreen 12 by the wiper blade 25.

As shown in FIG. 4, the first spring fastener 65 is formed as an aperture 67 formed between lateral sides 75 of the arm support 28. A hook 78 formed from wire coiled to form the spring 62 is provided adjacent to the first terminal end of the spring 62, and can be at least partially inserted into the aperture forming the first spring fastener 65. Similarly, a hook 79 also formed from the wire coiled to form the spring 62 is provided adjacent to the second terminal end of the spring 62, and can be secured to the second spring fastener 65 or any of the one or more additional spring fasteners 72 provided to the wiper arm 35. The second spring fastener 68 and the additional spring fastener 72 provided to the wiper arm 35 are formed as transversely-extending prongs that extend between two lateral sidewalls 82 of the wiper arm 35. However, it is to be noted that the first spring fastener 65, the second spring fastener 68 and each of the additional spring fasteners 72 provided to the wiper arm 35 can independently be selected from a group consisting of an aperture, a prong, an extension extending inwardly from a lateral wall 82 of the wiper arm 35, and any other suitable feature to which a hook 78, 79 provided adjacent to terminal ends of the spring 62 can be secured. Further, the hook 78, 79 provided adjacent to each terminal end of the spring 62 can be replaced by any suitable feature that can releasably secure the ends of the spring 62 or other biasing member between the desired spring fasteners 65, 68, 72.

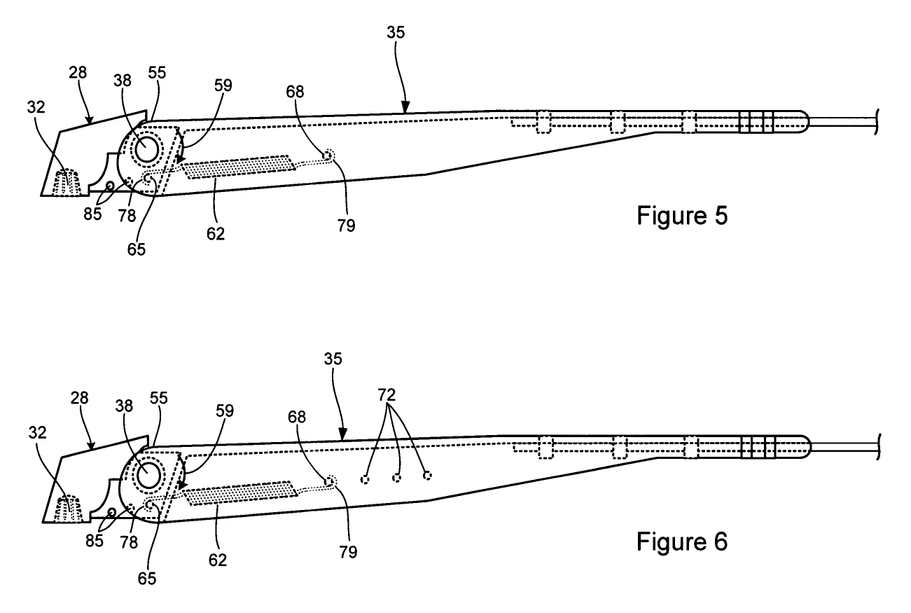

FIG. 5 shows an alternate embodiment of the present invention, wherein the arm support 28 is provided with a first spring fastener 65, and also at least one additional spring fastener 85. The at least one additional spring fastener 85 provided to the arm support 28 can include one additional spring fastener 85 or a plurality of additional spring fasteners 85 that are each separated from the second spring fastener 68 provided to the wiper arm 35 by different distances. Unlike the embodiments discussed above, the alternate embodiment shown in FIG. 5 includes only the second spring fastener 68 provided to the wiper arm 35. No additional spring fasteners are provided to the wiper arm 35 according to this embodiment. Instead, the additional spring fasteners 85 provided to the arm support 28 are arranged in series at ever increasing linear distances from the second spring fastener 68 provided to the wiper arm 35. In a manner analogous to that described above, a suitable bearing force F can be established by extending the spring 62 between the second spring fastener 68 of the wiper arm 35 and the first spring fastener 65 or one of the additional spring fasteners 85 provided to the arm support 28. Coupling one terminal end of the spring 62 to one of the additional spring fasteners 85 of the arm support 28 separated further from the second spring fastener 68 provided to the wiper arm 35 than the first spring fastener 65 results in a larger bearing force F than if the spring 62 was extended between the first and second spring fasteners 65, 68. Thus, when the motor vehicle 15 is being assembled, the desired bearing force F can be achieved by extending the spring between the second spring fastener 68 of the wiper arm 35 and the first spring fastener 65 or one of the additional spring fasteners 85 of the arm support 28.

Yet another illustrative embodiment is shown in FIG. 6. The windshield wiper 10 of FIG. 6 includes an arm support 28 with a first spring fastener 65 as well as at least one additional spring fastener 85. Likewise, the wiper arm 35 includes a second spring fastener 68 and at least one additional spring fastener 72. According to such an embodiment, a greater range of adjustment of the bearing force F can be accomplished due to the plurality of available spring fasteners provided to the arm support 28 and the wiper arm 35 to which the spring 62 can be secured. Just as before, the greater the linear distance the spring 62 must span between the spring fasteners to which it is coupled, the greater the resulting bearing force F with which the wiper blade 25 contacts the windscreen 12 will be. Accordingly, a range of bearing forces F are available at a time when the motor vehicle 15 is assembled. Thus, the windshield wiper 10 of the present invention offers the ability to adjust the bearing force F to a plurality of discrete levels when the motor vehicle 15 is assembled, as well as afterward when adjustment of the bearing force F is desired. The spring 62 can be coupled between two of a plurality of available discrete spring fasteners having fixed relative positions, thereby altering the bearing force F with which the wiper blade 25 contacts the windscreen 12. Thus, at least one, and optionally both the arm support 28 and the wiper arm 35 can be provided with at least one additional spring fastener to which the spring 62 can be coupled to achieve a desired bearing force F applied by the wiper blade 25 onto the windscreen 12.

Although the spring 62 is described above as a coiled spring that can be elongated when subjected to a tensile force, the spring of the present invention is not so limited. Instead, the spring 62 can be a helical spring that applies a uncoiling force on one of a plurality of suitable spring fasteners provided to the wiper arm 35, the arm support 28, or both the wiper arm 35 and the arm support 28. The embodiments including the coiled spring are described above merely to clearly and accurately describe the present invention, which includes a wiper blade 25 that can contact a windscreen 12 with a plurality of discrete bearing forces F.

Illustrative embodiments have been described, hereinabove. It will be apparent to those skilled in the art that the above devices and methods may incorporate changes and modifications without departing from the general scope of this invention. It is intended to include all such modifications and alterations in so far as they come within the scope of the appended claims.

1-26. (canceled)

27. A windshield wiper for clearing environmental debris from a windscreen provided to a motor vehicle comprising:
an arm support to be coupled to a rotatable pivot head provided to the motor vehicle for oscillating the windshield wiper during operation thereof;
a wiper arm coupled to the arm support and supporting a wiper blade tat contacts the windscreen with a desired bearing force;
a first spring fastener provided to the arm support;
a second spring fastener provided to the wiper arm and separated from the first spring fastener by a first distance;
at least one additional spring fastener provided to the wiper arm and separated a second distance from the first spring fastener, wherein
the first and second distances are different; and
a spring having a first end coupled to the first spring fastener and a second end that is coupled to the second spring fastener or the additional spring fastener to establish the desired bearing force with which the wiper blade contacts the windscreen.

28. The windshield wiper according to claim 27 further comprising a plurality of additional spring fasteners provided to the wiper arm, each being separated from the first spring fastener provided to the arm support by a different distance.

29. The windshield wiper according to claim 27 further comprising an auxiliary spring fastener provided to the arm support and separated from the second spring fastener by a predetermined distance.

30. The windshield wiper according to claim 29 further comprising a plurality of auxiliary spring fasteners provided to the arm support, each being separated from the second spring fastener by a different distance.

31. The windshield wiper according to claim 27, wherein the first spring fastener, the second spring fastener and the at least one additional spring fastener are independently selected from the group consisting of an aperture and a protrusion.

32. The windshield wiper according to claim 77 wherein the second spring fastener and the at least one additional spring fastener are exposed to an interior cavity of the wiper arm and the spring is at least partially disposed within the cavity.

33. The windshield wiper according to claim 27, wherein the first spring fastener, the second spring fastener and the at least one additional spring fastener are fixed at discrete locations and the first and second distances are fixed.

34. The windshield wiper according to claim 27 further comprising a hinge pin for pivotally coupling the wiper arm to the arm support and about which the wiper arm can pivot.

35. A windshield wiper for clearing environmental debris from a windscreen provided to a motor vehicle comprising:
an arm support to be coupled to a rotatable pivot head provided to the motor vehicle for oscillating the windshield wiper during operation thereof;
a wiper arm coupled to the arm support and supporting a wiper blade that contacts the windscreen with a desired bearing force;
a first spring fastener provided to the arm support;
a second spring fastener provided to the wiper arm and separated from the first spring fastener by a first distance;
at least one additional spring fastener provided to the arm support and separated a second distance from the second spring fastener, wherein
the first and second distances are different; and
a spring having a second end coupled to the second spring fastener and a first end that is coupled to the first spring fastener or the additional spring fastener to establish the desired bearing force with which the wiper blade contacts the windscreen.

36. The windshield wiper according to claim 35 further comprising a plurality of additional spring fasteners provided to the arm support, each being separated from the second spring fastener provided to the wiper arm by a different distance.

37. The windshield wiper according to claim 35 further comprising an additional spring fastener provided to me wiper arm and separated from the first spring fastener by a predetermined distance.

38. The windshield wiper according to claim 37 further comprising a plurality of additional spring fasteners provided to the wiper arm, each being separated from the first spring fastener by a different distance.

39. The windshield wiper according to claim 35, wherein the first spring fastener, the second spring fastener and the at least one additional spring fastener are independently selected from the group consisting of an aperture and a protrusion.

40. The windshield wiper according to claim 35, wherein the second spring fastener is exposed to an interior cavity of the wiper arm and the spring is also at least partially disposed within the cavity.

41. The windshield wiper according to claim 35, wherein the first spring fastener, the second spring fastener and the at least one additional spring fastener are fixed at discrete locations and the first and second distances are also fixed.

42. The windshield wiper according to claim 35 further comprising a hinge pin for pivotally coupling the wiper arm to the arm support and about which the wiper arm can pivot.
